(19) United States
(12) Patent Application Publication
(10) Pub. No.: US 2024/0408753 A1
(43) Pub. Date: Dec. 12, 2024

(54) PROGRAM CREATION DEVICE, CONTROL DEVICE, AND MACHINE SYSTEM

(71) Applicant: FANUC CORPORATION, Yamanashi (JP)

(72) Inventor: Hiroyuki YONEYAMA, Yamanashi (JP)

(21) Appl. No.: 18/701,253

(22) PCT Filed: Oct. 29, 2021
(86) PCT No.: PCT/JP2021/040135

§ 371 Date: Apr. 15, 2024

(51) Int. Cl. B25J 9/16

(52) U.S. Cl. CPC B25J 9/1661; B25J 9/1664

(57) ABSTRACT

This program creation device comprises an operation command adjustment unit that adjusts an operation command in a machine operation program, on the basis of changes in the posture of a section to be controlled in a machine, such changes being per unit of distance or unit of time with respect to the movement path of the section to be controlled.

### TECHNICAL FIELD

The present invention relates to program creation technology or control technology, for a machine, and in particular to program creation devices, controllers, and mechanical systems.

### BACKGROUND ART

In general, when creating an operation program for a machine including a robot, a machine tool, or the like, the programmer jogs the machine and teaches the teaching points manually by adjusting them one by one on the movement path of the control objective part of the machine, or places a shape model of the machine, tool, workpiece, or the like, such as a CAD (computer aided design) model, on a virtual space and the programmer jogs the shape model of the machine and teaches the teaching points manually by adjusting them one by one.

In addition, there are techniques for easily creating a machine operation program by using a shape model, such as specifying ridges on a workpiece shape model and automatically generating an operation program for the machine to move the tool along the specified ridges, or selecting a workpiece shape model and automatically generating an operation program for the machine to handle the workpiece.

On the other hand, in a movement path in which the movement distance of the control objective part is relatively short with respect to the orientation change of the control objective part of the machine, even when an operating speed is set relatively low, the orientation change of the control objective part may be very fast. During the creation of an operation program, it is difficult to predict a rapid orientation change of the control objective part. When the generated operation program is actually executed by the machine, the orientation of the control objective part changes unnaturally and rapidly, which may cause safety problems such as the machine coming into contact with objects or the like in the vicinity, or reliability problems such as the electric motor that drives the machine being overloaded, stopping the machine.

Patent Literature 1 describes that the orientation data portion in the first row in the teaching data file output from the CAD system is read into a variable Dpre, then the orientation data portion in the next row is read into a variable Dcur, and the magnitude of the difference |Dpre−Dcur| between both Dpre and Dcur is evaluated, and, when the difference is larger than a reference quantity, the joint angles are considered to have changed rapidly and the conversion is performed into alternate orientation data, which is substituted into the variable Dcur, and the content of the variable Dpre is updated to the content of the variable Dcur.

Patent Literature 2 describes that the orientation of the tool attached to the tip of the industrial robot is calculated so as to correspond to a normal vector perpendicular to the plane of the workpiece at each teaching point, the teaching point at which the calculated orientation of the tool becomes indefinite is detected, the detected teaching point is defined as a singular point, and the orientation of the tool at the singular point is recalculated, determining the orientation of the tool at each teaching point.

Patent Literature 3 describes that a speed vP is reduced to a first condition speed v1 when an angle θ formed by the line segment from a teaching point P−1 upstream of the movement path to a teaching point P for which speed is to be set and the line segment from the teaching point P to a teaching point P+1 downstream is large, or the speed vP is reduced to a second condition speed when the orientation of the teaching point P is greatly changed from the orientation of the robot at a teaching point P−1 upstream of the movement path.

### CITATION LIST

### Patent Literature

PTL 1: Japanese Unexamined Patent Publication No. 04-268607A
PTL 2: Japanese Unexamined Patent Publication No. 09-254062A
PTL 3: Japanese Unexamined Patent Publication No. 2015-123517A

### SUMMARY OF INVENTION

### Technical Problem

It is an object of the present invention to provide a program creation technique or a control technique of a machine with high safety and reliability in view of problems in the related art.

### Solution to Problem

An aspect of the present disclosure provides a program creation device, which includes an operation instruction adjusting unit configured to adjust an operation instruction in an operation program of a machine, based on an orientation change of a control objective part of the machine per unit distance or unit time in a movement path of the control objective part.

Another aspect of the present disclosure provides a program creation device, which includes a section detecting unit configured to detect a section in which an orientation change of a control objective part of a machine per unit distance or unit time in a movement path of the control objective part is equal to or greater than a threshold value.

Alternative aspect of the present disclosure provides a controller, which includes: an operation instruction adjusting unit configured to adjust an operation instruction of a machine, based on an orientation change of a control objective part of the machine per unit distance or unit time in a movement path of the control objective part; and a control unit configured to control the operation of the machine according to the adjusted operation instruction.

Still another aspect of the present disclosure provides a mechanical system, which includes: a machine; an operation instruction adjusting unit configured to adjust an operation instruction of a machine, based on an orientation change of a control objective part of the machine per unit distance or unit time in a movement path of the control objective part; and a control unit configured to control the operation of the machine according to the adjusted operation instruction.

### Advantageous Effects of Invention

According to one aspect of the present disclosure, the operation instruction in which the orientation of the control objective part changes rapidly can be automatically adjusted. Thus, the time required to modify the operation program, which has a particularly large number of teaching points, can be shortened. This provides an operation program of a machine with high safety and reliability.

According to another aspect of the present disclosure, a section in which the orientation of the control objective part changes rapidly can be automatically detected. Thus, the time required to modify the operation program, which has a particularly large number of teaching points, can be shortened. This provides an operation program of a machine with high safety and reliability.

According to alternative aspect of the present disclosure, since the controller includes an operation instruction adjusting unit, the operation instruction in which the orientation of the control objective part changes rapidly can be automatically adjusted, and the operation of the machine can be controlled according to the adjusted operation instruction. This provides a control technique of a machine with high safety and reliability.

According to still another aspect of the present disclosure, since the mechanical system includes an operation instruction adjusting unit, the operation instruction in which the orientation of the control objective part changes rapidly can be automatically adjusted and the operation of the machine can be controlled according to the adjusted operation instruction. This provides a control technique of a machine with high safety and reliability.

### BRIEF DESCRIPTION OF DRAWINGS

FIG. 1 is a schematic configuration diagram of a mechanical system according to an embodiment.

FIG. 2 is a block diagram of a mechanical system according to an embodiment.

FIG. 3A is a diagram illustrating an example of an operation trajectory that includes a relatively long section.

FIG. 3B is a diagram illustrating an example of an operation trajectory that includes a relatively long section.

FIG. 4A is a diagram illustrating an example of an operation trajectory that includes a relatively short section.

FIG. 4B is a diagram illustrating an example of an operation trajectory that includes a relatively short section.

FIG. 5A is a diagram illustrating an example of a section detection window.

FIG. 5B is a diagram illustrating an example of an operation instruction adjusting window.

FIG. 5C is a diagram illustrating an example of an operation instruction adjusting method selection window.

FIG. 6A is a diagram illustrating an example of an operation trajectory that does not include a rapid orientation change.

FIG. 6B is a diagram illustrating an example of an operation trajectory that includes a rapid orientation change.

FIG. 7 is a diagram illustrating an example of an operating speed window that includes a rapid orientation change.

FIG. 8A is a diagram illustrating an example of a program editing window after an operating speed change.

FIG. 8B is a diagram illustrating a modified example of a program editing window after an operating speed change.

FIG. 9A is a diagram illustrating an example of an operation trajectory window after an operation form change.

FIG. 9B is a diagram illustrating an example of an operation trajectory window after an operation form change.

FIG. 10 is a diagram illustrating an example of a program editing window after an operation form change.

### DESCRIPTION OF EMBODIMENTS

Embodiments of the present disclosure will be described in detail with reference to the accompanying drawings hereafter. In each drawing, the same or similar constituent elements are given the same or similar signs. Further, the embodiments described below do not limit the technical scope of the invention and the meaning of the terms described in the claims. In the present document, the term “screen” means an entire or partial region of a display for display, and the term “window” means a partial region of the screen.

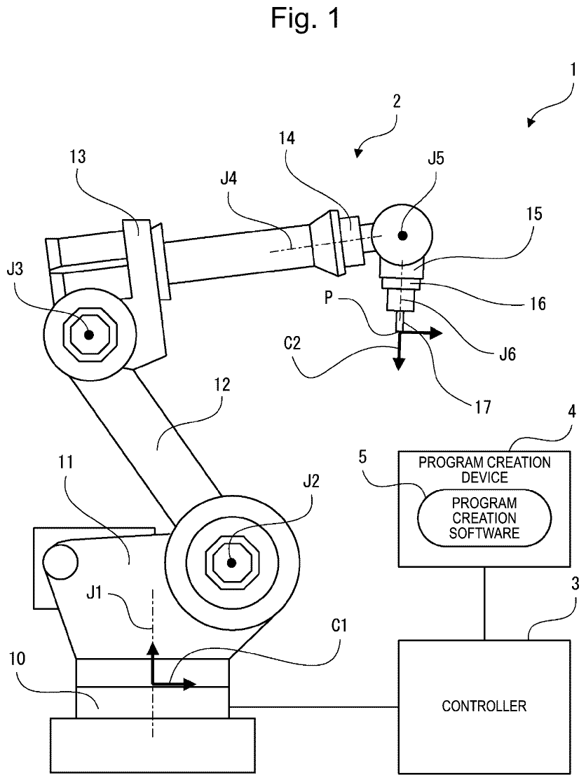

FIG. 1 is a schematic configuration diagram of a mechanical system 1 according to an embodiment. The mechanical system 1 is a robot system, but is not limited thereto, and in other embodiments, the mechanical system 1 may be composed of other mechanical systems such as a machine tool system, a construction mechanical system, a vehicle system, an aircraft system, or a rocket system. The mechanical system 1 includes a machine 2, a controller 3, and a program creation device 4. The machine 2, the controller 3, and the program creation device 4 are connected to each other via wire or radio, or are connectable to each other via wire or radio. The machine 2 is controlled by the controller 3 according to the operation program, and the controller 3 executes the operation program for the machine 2 created by the program creation device 4.

The machine 2 is composed of, but is not limited to, an industrial robot, such as an articulated robot, and in other embodiments, the machine 2 may be composed of other robots, such as a parallel link type robot, an orthogonal robot, a humanoid, or a dual arm robot. It should be noted that, alternatively, in other embodiments, the machine 2 may be composed of other machines, such as a machine tool, a construction machine, a vehicle, an aircraft, or a rocket. The machine 2 includes a first link 10 to a seventh link 16. The first link 10 is a base fixed at a predetermined position and a second link 11 is a rotary barrel that is rotatably supported with respect to the first link 10 around a first axis line J1. A third link 12 is a first arm that is rotatably supported with respect to a rotary barrel 11 around a second axis line J2 orthogonal to the first axis line J1, and a fourth link 13 is a second arm that is rotatably supported with respect to the third link 12 around a third axis line J3 parallel to the second axis line J2. A fifth link 14 to the seventh link 16 are triaxial wrist units that are attached to the tip of the fourth link 13.

The fifth link 14 is a first wrist element that is rotatably supported with respect to a second arm 13 around a fourth axis line J4 orthogonal to the third axis line J3. A sixth link 15 is a second wrist element that is rotatably supported with respect to the fifth link 14 around a fifth axis line J5 orthogonal to the fourth axis line J4. The seventh link 16 is a third wrist element that is rotatably supported with respect to a second wrist element 15 around a sixth axis line J6 orthogonal to the fifth axis line J5. The machine 2 also includes a tool 17 that is detachably attached to the tip of the wrist unit. The tool 17 is composed of various tools such as a hand, a welding tool, a cutting tool, a drilling tool, and a painting tool.

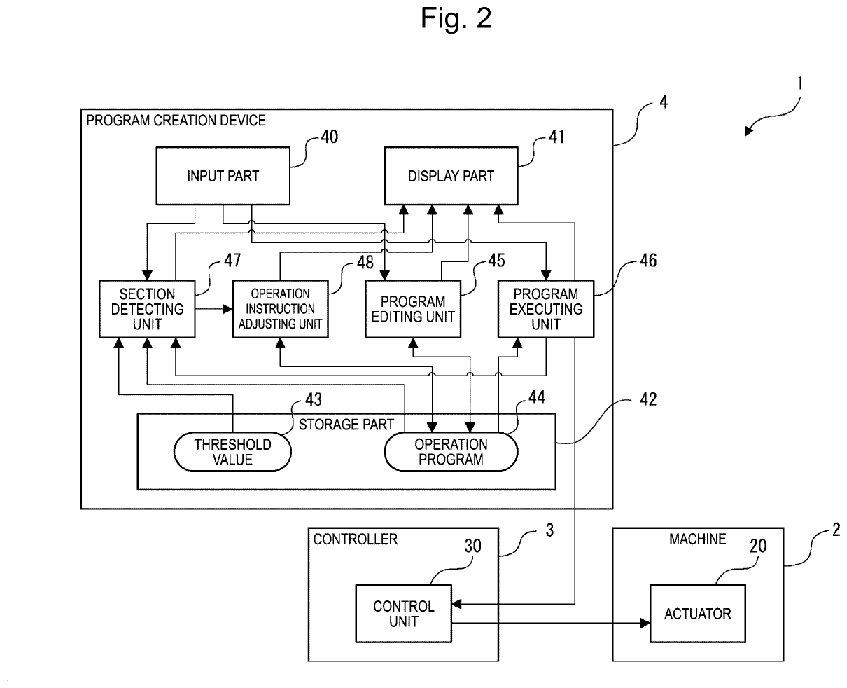

As described above, the machine 2 includes a plurality of interconnected links 10 to 16. The machine 2 includes, but is not limited to, joint axes that rotate around predetermined axis lines J1 to J6 between a plurality of links 10 to 16. In other embodiments, the machine 2 may include a joint axis that moves linearly along a predetermined axis line between the plurality of links 10 to 16. The machine 2 further includes an actuator (see FIG. 2) for driving each joint axis and an actuator (see FIG. 2) for driving the tool 17. Although the actuator includes an electric actuator that includes an electric motor, a reduction gear, or the like, in other embodiments, the actuator may include other actuators such as a fluid actuator including a fluid pump, a fluid cylinder, or the like. The actuator may also further include one or more drive circuits for driving itself.

Although not illustrated, the controller 3 includes a programmable logic controller (PLC). Alternatively, in other embodiments, the controller 3 may include other processors or other semiconductor integrated circuits. Although not illustrated in the figures, the controller 3 includes processors, memories, input and output interfaces, or the like that are connected to each other via a bus. The processor executes programs stored in the memory and controls various devices. The memory stores various programs and various data, and the input and output interface inputs and outputs data between the processor and memory and various external devices. The controller 3 may further include one or more drive circuits that drive and control the actuator of the machine 2. For example, the drive circuit is a servo amplifier that drives and controls the actuator based on the operation instruction input from the processor. The controller 3 inputs the operation program of the machine 2 from the program creation device 4 via the input and output interface, executes the operation program by the processor, transmits the operation instruction to the drive circuit and drives the actuator, which operates the machine 2.

Although the program creation device 4 includes a computer such as a personal computer (PC) or a tablet-type computer, in other embodiments, the program creation device 4 may include a teaching device for a robot such as a teach pendant or a teaching operation panel. Although not illustrated in the figures, the program creation device 4 includes a processor, a memory, an input and output interface, or the like, which are connected to each other via a bus. The processor executes programs stored in the memory and controls various devices. The memory stores various programs and various data, and the input and output interface inputs and outputs data between the processor and memory and various external devices. The program creation device 4 creates the operation program for the machine 2 and transmits the created operation program to the controller 3 via the input and output interface.

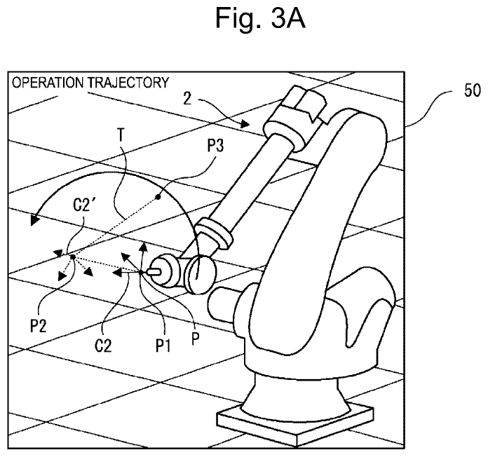

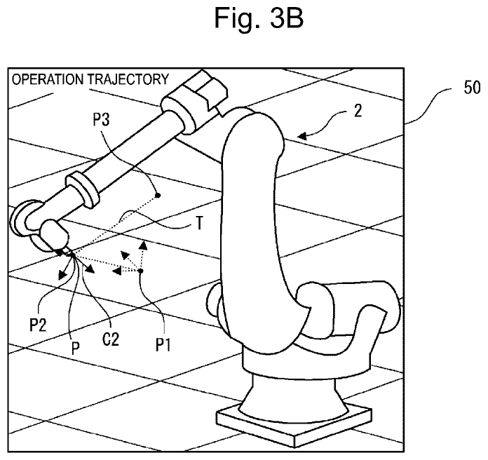

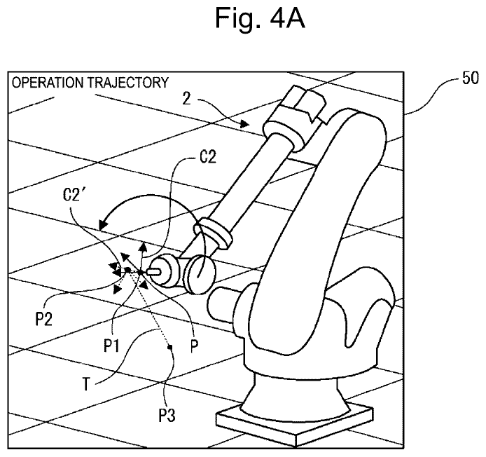

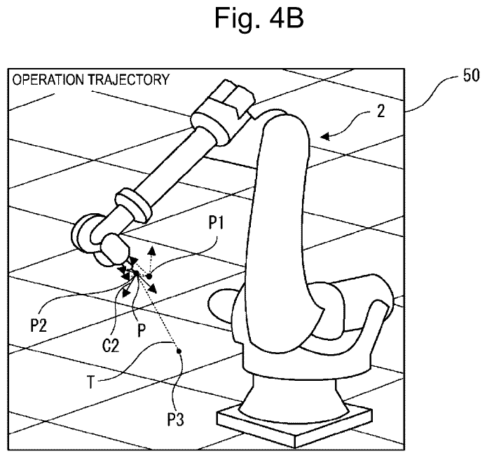

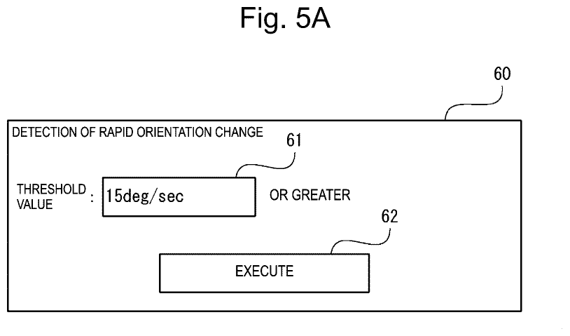

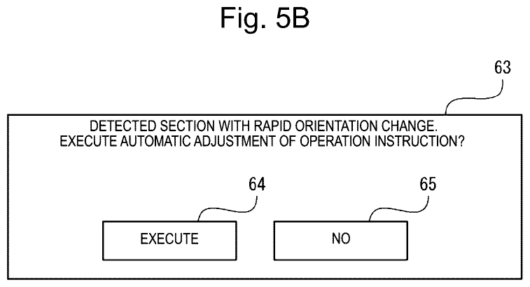

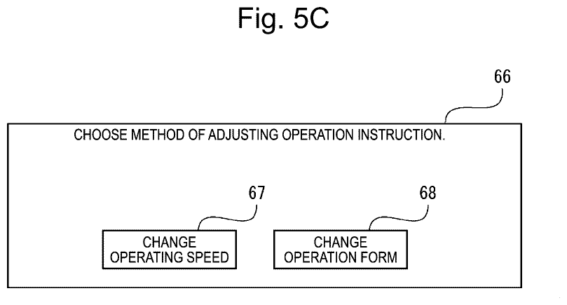

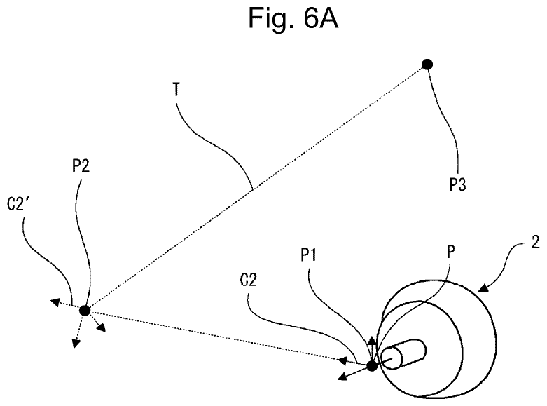

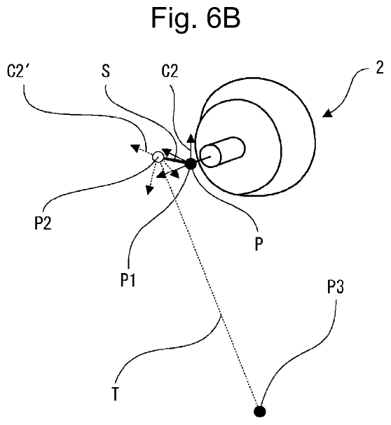

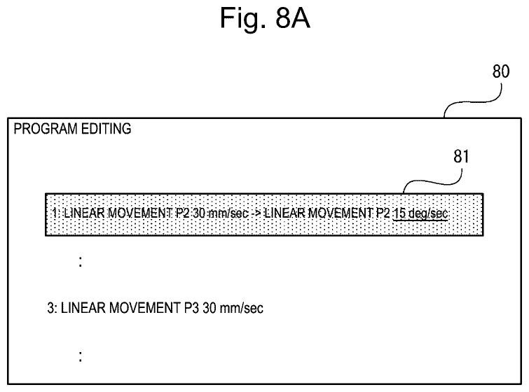

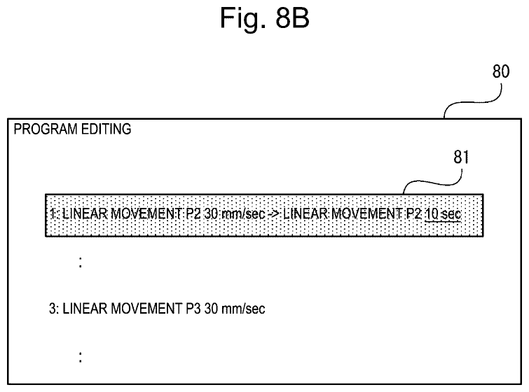

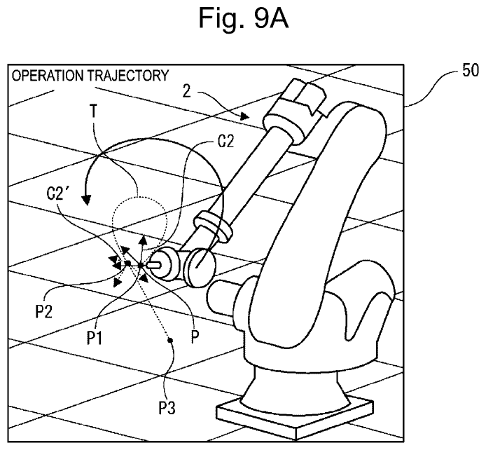

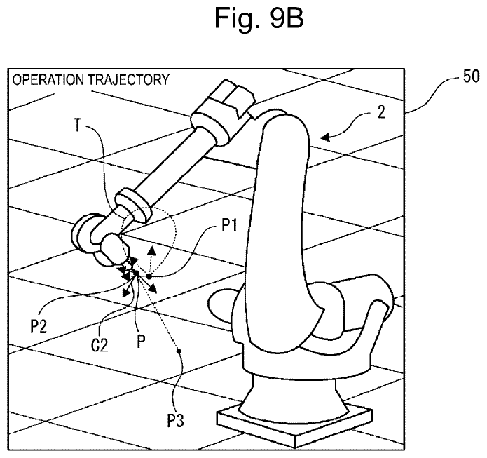

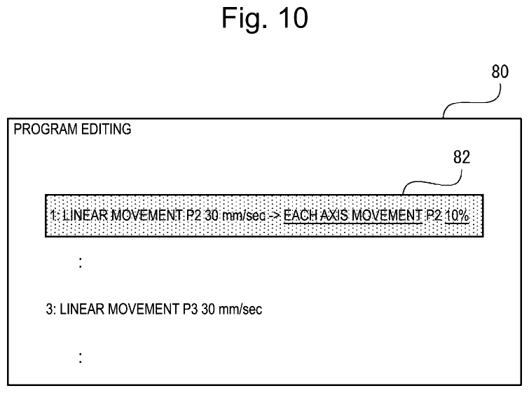

The program creation device 4 includes a program creation software 5 for editing, executing, generating, or the like, the operation program for the machine 2. The program creation software 5 is stored at the memory and executed by the processor. The program creation software 5 displays a programming screen that includes various windows such as the operation trajectory window (see FIG. 3A to FIG. 4B, FIG. 6A to FIG. 6B, and FIG. 9A to FIG. 9B), the program editing window (see FIG. 8A to FIG. 8B, and FIG. 10), the section detection window (see FIG. 5A), the operation instruction adjusting window (see FIG. 5B), and the operation instruction adjusting method selection window (see FIG. 5C) at the display part, as described below.

The program creation software 5 includes a coordinate system setting function for setting various coordinate systems such as a world coordinate system, a machine coordinate system, a flange coordinate system, a tool coordinate system, a camera coordinate system, a workpiece coordinate system, and a user coordinate system. Although these coordinate systems are composed of orthogonal coordinate systems, in other embodiments, these coordinate systems may be composed of other coordinate systems such as oblique orthogonal coordinate systems, polar coordinate systems. For ease of explanation, the program creation software 5 is assumed to set a machine coordinate system C1 and a tool coordinate system C2. The machine coordinate system C1 is fixed to the reference point of the machine 2, for example, the base, and the tool coordinate system C2 is fixed to the reference point of the tool 17, for example, the tool center point (TCP).

The machine 2 includes a control objective part P that is a control point. The position of the control objective part P is represented by the position of the tool coordinate system C2 in the machine coordinate system C1, for example, the X-Y-Z coordinate values (x, y, z). Alternatively, in other embodiments, the position of the control objective part P may be the position of the flange coordinate system in the machine coordinate system C1, i.e., the flange position of the wrist unit, or the position of the tool coordinate system C2 in the world coordinate system, or the like. The orientation of the control objective part P is represented by the orientation of the tool coordinate system C2 in the machine coordinate system C1, for example, the rotation amounts (w, p, r) around the X-Y-Z axes. Alternatively, in other embodiments, the orientation of the control objective part P may be the orientation of the flange coordinate system in the machine coordinate system C1, i.e., the flange orientation of the wrist unit, or the orientation of the tool coordinate system C2 in the world coordinate system, or the like.

The program creation software 5 further includes a teaching point setting function for setting one or more teaching points that constitute the operation trajectory of the control objective part P. Each teaching point includes at least the position of the control objective part P, such as the X-Y-Z coordinate values (x, y, z), and, as needed, the orientation of the control objective part P, such as the rotation amounts (w, p, r) around the X-Y-Z axes.

The program creation software 5 further includes an operation instruction editing function that arranges and edits the operation instructions of the machine 2 in time series. The operation instruction includes an operation instruction of the control objective part P, an operation instruction of the tool 17, and an application instruction combining these operation instructions. The operation instruction of the control objective part P includes various parameters such as a teaching point, an operation form, a speed form, and a speed parameter. The operation form of the operation instruction includes various operation forms such as a linear movement (linear movement of the control objective part P), an arc movement (arc movement of the control objective part P), and each axis movement (movement of the control objective part P in which the movement path of the control objective part P is not constrained and the actuator of each joint axis operates independently). The speed form of the operation instruction includes various speed forms such as the movement speed of the control objective part P, the operating speed of the actuator of each joint axis, the orientation change speed of the control objective part P, and the movement time between the teaching points. The speed parameter of the operation instruction includes various speed parameters such as the operating speed or the operating time in response to the speed form. The operation instruction of the tool 17 includes various parameters in response to the tool such as hand opening/closing, gripping strength, or the like, and the application instruction includes various parameters in response to the application such as palletizing, depalletizing, or the like.

The program creation software 5 further includes a teaching point association function that associates one or more teaching points constituting the operation trajectory of the control objective part P with the operation instruction. For example, the teaching point at the target position of the linear movement is caused to be associated with the operation instruction of the linear movement. Alternatively, for example, a plurality of teaching points at an intermediate position or a target position of the arc movement are caused to be associated with the operation instruction of the arc movement. The program creation software 5 edits the operation program of the machine 2 by various editing functions as described above.

The program creation software 5 further includes a program execution function for executing the edited operation program online (connected to the actual machine) or offline (not connected to the actual machine) and confirming the operation of the machine 2. The program creation software 5 may also further include a program generation function for generating an operation program. The operation program that is edited, or executed and confirmed, is converted from the source code to the object code (machine word), intermediate code, byte code, or the like, and a final operation program is generated. The program creation device 4 transmits the created operation program to the controller 3 via the input and output interface.

FIG. 2 is a block diagram of the mechanical system 1 according to an embodiment. The program creation device 4 includes an input part 40, a display part 41, and a storage part 42. The input part 40 is composed of a user interface (UI) such as a keyboard or a mouse, and the display part 41 is composed of a UI such as, but not limited to, a display, or the like. In other embodiments, the input part 40 and the display part 41 may be composed of an integrated UI such as a touch panel display. The storage part 42 is composed of a memory such as a RAM (random access memory) and a ROM (read only memory).

The program creation device 4 further includes a program editing unit 45, a program executing unit 46, a section detecting unit 47, and an operation instruction adjusting unit 48, which are part of the program creation software 5. These constituent elements may be composed of a part or all of a program executed at a processor, but in other embodiments, these constituent elements may be composed of a part or all of another semiconductor integrated circuit such as a field programmable gate array (FPGA), an application specific integrated circuit (ASIC), or the like.

The controller 3 includes a control unit 30 that controls the operation of the machine 2. While the control unit 30 includes a control circuit that includes a PLC, in other embodiments, the control unit 30 may further include one or more drive circuits that drive and control an actuator 20 of the machine 2. The control unit 30 controls the operation of the machine 2 according to an operation program 44 created at the program creation device 4. Alternatively, in another embodiment, the controller 3 may include all constituent elements of the program creation device 4. In other words, the controller 3 may include an input part 40, the display part 41, the storage part 42, the program editing unit 45, the program executing unit 46, the section detecting unit 47, the operation instruction adjusting unit 48, or the like.

The machine 2 includes one or more actuators 20 that drive the machine 2. The actuator 20 includes an actuator for driving each joint axis, an actuator for driving the tool 17, or the like. Although the actuator 20 includes an electric actuator that includes an electric motor, a reduction gear, or the like, in other embodiments, the actuator 20 may include other actuators such as a fluid actuator including a fluid pump, a fluid cylinder, or the like. The actuator 20 may also further include one or more drive circuits for driving itself.

The program editing unit 45 displays at the display part 41 an operation trajectory window 50 (see FIG. 3A to FIG. 4B, FIG. 6A to FIG. 6B, FIG. 9A to FIG. 9B, or the like) that includes the above-described coordinate system setting function, the teaching point setting function, or the like, and displays at the display part 41 a program editing window 80 (see FIG. 8A to FIG. 8B, FIG. 10, or the like) that includes the above-described operation instruction editing function, the teaching point association function, or the like. The program editing unit 45 edits the coordinate system, teaching point, operation instruction, or the like, based on various commands input from the input part 40, stores the edited operation program 44 at the storage part 42, and displays the edited operation program 44 at the program editing window 80. The program editing function allows the user to edit the operation program 44.

The program executing unit 46 displays a program execution window (not illustrated) that includes the above-described program execution function at the display part 41. The program executing unit 46 executes the edited operation program 44 offline, based on various commands input from the input part 40, and operates the virtual machine 2 displayed at the display part 41 on the virtual space. Alternatively, in another embodiment, the program executing unit 46 transmits the edited operation program 44 to the controller 3, based on various commands input from the input part 40, and executes the operation program 44 online and operates the machine 2 on the real space. By the program execution function, the user confirms the operation of the machine 2 by the edited operation program 44. The program executing unit 46 may include the above-described program generation function.

During the creation of the operation program 44 as described above, it is difficult to predict a rapid orientation change of the control objective part P. When the generated operation program is actually executed by the machine 2, the orientation of the control objective part P changes unnaturally and rapidly, which may cause safety problems such as the machine 2 coming into contact with objects or the like in the vicinity, or reliability problems such as the electric motor that drives the machine 2 being overloaded, stopping the machine 2. Thus, the program creation device 4 includes the section detecting unit 47 for detecting a section in which the orientation of the control objective part P changes rapidly, and the operation instruction adjusting unit 48 for adjusting the operation instruction of the section.

The section detecting unit 47 detects a section in which the orientation change of the control objective part P per unit distance or unit time in the movement path of the control objective part P is a threshold value 43 or greater. The orientation change per unit distance or unit time may be, for example, the sum of the respective rotation amounts around the X-Y-Z axes (e.g., the sum of the respective rotation angles) divided by the unit distance (e.g., millimeter) or the unit time (e.g., second). The threshold value 43 of the orientation change per unit distance or unit time is previously input from the input part 40 or previously stored in the storage part 42.

The section detecting unit 47 evaluates the distance between the teaching points in the operation program 44, the operating speed or operating time between the teaching points, and the orientation change of the control objective part P between the teaching points, which detects sections in which the orientation change of the control objective part P per unit distance or unit time is the threshold value 43 or greater. Alternatively or additionally, the section detecting unit 47 may sequentially evaluate the orientation change per unit distance or unit time during the execution of the operation program 44, which detects sections in which the orientation change per unit distance or unit time is the threshold value 43 or greater. The section detecting function allows for automatically detecting sections in which the orientation of the control objective part P changes rapidly from within the operation program 44 or during the execution of the operation program 44. Thus, the time required to modify the operation program 44, which includes a particularly large number of teaching points, can be shortened. This provides the operation program 44 of the machine 2 with high safety and reliability.

The display part 41 displays the operation trajectory that highlights the detected section with the large orientation change or the teaching points constituting the section (the operation trajectory window 50 of FIG. 6B is displayed) based on the command of the section detecting unit 47. The section highlighting function enables the user to visually and easily recognize the section in which the orientation of the control objective part P changes rapidly. The display part 41 displays an execution confirmation whether or not the operation instruction of the section in which the orientation of the control objective part P changes rapidly is automatically adjusted, based on the command of the section detecting unit 47 (an operation instruction adjusting window 63 in FIG. 5B is displayed). The operation instruction adjustment confirmation function allows the user to optionally select automatic adjustment or manual adjustment of the operation instruction.

The operation instruction adjusting unit 48 adjusts the operation instruction in the operation program 44 of the machine 2 based on the orientation change of the control objective part P per unit distance or unit time. In other words, the operation instruction adjusting unit 48 adjusts the operation instruction of the section in which the orientation change of the control objective part P per unit distance or unit time is the threshold value 43 or greater. The operation instruction adjusting unit 48 includes, as a method of adjusting the operation instruction, at least one selected from a group of an operating speed change function for changing the operating speed of the operation instruction and an operation form change function for changing the operation form of the operation instruction.

The operating speed change function is a function for changing the speed form of the operation instruction and the speed parameter corresponding to the speed form. For example, the operating speed change function changes the speed form of the movement speed of the control objective part P to the speed form of the orientation change speed of the control objective part P, and decelerates the speed parameter of the orientation change speed of the control objective part P to a predetermined value or less. Alternatively, in another embodiment, the operating speed change function may change the speed form of the movement speed of the control objective part P to the speed form of the movement time between the teaching points of the control objective part P, and increase the speed parameter of the movement time between the teaching points of the control objective part P to a predetermined value or greater.

Alternatively, in another embodiment, the operating speed change function changes the speed form of the operating speed of the actuator 20 of each joint axis to the speed form of the orientation change speed of the control objective part P, and decelerates the speed parameter of the orientation change speed of the control objective part P to a predetermined value or less. Alternatively, in still another embodiment, the operating speed change function may change the speed form of the operating speed of the actuator 20 of each joint axis to a speed form of the movement time between the teaching points of the control objective part P, and increase the speed parameter of the movement time between the teaching points of the control objective part P to a predetermined value or greater. By changing the speed form, the user can intuitively recognize the orientation change of the control objective part P after the change. By changing the speed parameter, the rapid orientation change of the control objective part P can be suppressed. This provides the operation program 44 of a machine with high safety and reliability.

The operation form change function is a function for changing to an operation form in which the movement distance of the control objective part P is extended. For example, the operation form change function changes the operation form of the linear movement of the control objective part P to the operation form of each axis movement, and, as needed, decelerates the speed parameter of the operating speed of the actuator 20 of each joint axis to a predetermined value or less. Since the movement distance of the control objective part P in the operation form of each axis movement is longer than the movement distance of the control objective part P in the operation form of the linear movement, the rapid orientation change of the control objective part P can be suppressed.

Alternatively, in another embodiment, the operation form change function changes the operation form of the linear movement of the control objective part P to an operation form of an arc movement, and, as needed, decelerates the operating speed of the control objective part P to a predetermined value or less. Since the movement distance of the control objective part P in the operation form of the arc movement is longer than the movement distance of the control objective part P in the operation form of the linear movement, the rapid orientation change of the control objective part P can be suppressed. By the operation form change function, the movement distance of the control objective part P is extended, and, as needed, the operating speed is decelerated to a predetermined value or less, so that a rapid orientation change of the control objective part P can be suppressed. This provides the operation program 44 of a machine with high safety and reliability.

The operation instruction adjusting unit 48 stores the operation program 44 including the adjusted operation instruction at the storage part 42 and displays the operation program 44 including the adjusted operation instruction at the display part 41 (displays the program editing window 80 in FIG. 8A to FIG. 8B and FIG. 10). The display part 41 displays the operation program 44 highlighting the adjusted operation instruction based on the command of the operation instruction adjusting unit 48 (displays the program editing window 80 in FIG. 8A to FIG. 8B and FIG. 10). The display part 41 displays the operation program 44 that simultaneously displays the operation instruction before adjusting and the operation instruction after adjusting based on the command of the operation instruction adjusting unit 48 (displays the program editing window 80 in FIG. 8A to FIG. 8B and FIG. 10). The operation instruction highlighting function enables the user to visually and easily recognize the automatically adjusted operation instruction. In addition, the operation instruction display function before and after adjusting enables the user to visually and easily recognize how the operation instruction has been automatically adjusted.

An example of the mechanical system 1 will be described below. FIG. 3A and FIG. 3B illustrate an example of an operation trajectory T including a relatively long section (see between the teaching points P1 to P2). The operation trajectory window 50 displays the virtual machine 2 and the operation trajectory T of the control objective part P on the virtual space. In the present example, the operation trajectory T of the control objective part P is composed of a plurality of teaching points P1 to P3. Both a teaching point P2 and a teaching point P3 are associated with an operation instruction for linear movement. In FIG. 3A, the control objective part P is at a teaching point P1, and the orientation of the control objective part P is represented in the tool coordinate system C2. The orientation of the control objective part P at the teaching point P2 is represented in the tool coordinate system C2′. In FIG. 3B, the control objective part P is at the teaching point P2 and the orientation of the control objective part P is represented by the tool coordinate system C2.

In this regard, when the movement speed of the control objective part P is 50 mm/sec, the distance between the teaching point P1 and the teaching point P2 is 500 mm, and the orientation change (i.e., the orientation change from the tool coordinate system C2 to the tool coordinate system C2′) of the control objective part P between the teaching point P1 and the teaching point P2 is 150 degrees, the orientation change between the teaching point P1 and the teaching point P2 is controlled in time division during the movement time 10 seconds (=500/50) of the control objective part P between the teaching point P1 and the teaching point P2, thus the orientation change per unit time is 15 deg/sec (=150/10). The orientation change per unit distance is 0.3 deg/mm (=150/500). In other words, in the present example, since the distance between the teaching point P1 and the teaching point P2 is relatively long, the orientation of the control objective part P does not change rapidly.

FIG. 4A and FIG. 4B illustrate an example of the operation trajectory T including a relatively short section (see between the teaching points P1 to P2). The operation trajectory window 50 displays the virtual machine 2 and the operation trajectory T of the control objective part P on the virtual space. In the present example, the operation trajectory T of the control objective part P is composed of a plurality of teaching points P1 to P3. Both the teaching point P2 and the teaching point P3 are associated with an operation instruction for linear movement. In FIG. 4A, the control objective part P is at the teaching point P1, and the orientation of control objective part P is represented in the tool coordinate system C2. The orientation of the control objective part P at the teaching point P2 is represented in the tool coordinate system C2′. In FIG. 4B, the control objective part P is at the teaching point P2 and the orientation of the control objective part P is represented in the tool coordinate system C2.

In this regard, when the movement speed of the control objective part P is 50 mm/sec, the distance between the teaching point P1 and the teaching point P2 is 50 mm, and the orientation change (i.e., the orientation change from the tool coordinate system C2 to the tool coordinate system C2′) of the control objective part P between the teaching point P1 and the teaching point P2 is 150 degrees, the orientation change between the teaching point P1 and the teaching point P2 is controlled in time division during the movement time 1 second (=50/50) of the control objective part P between the teaching point P1 and the teaching point P2, thus the orientation change per unit time is 150 deg/sec (=150/1). The orientation change per unit distance is 3 deg/mm (=150/50). In other words, in the present example, since the distance between the teaching point P1 and the teaching point P2 is relatively short, the orientation of the control objective part P changes rapidly. The section detecting unit 47 automatically detects the section (between the teaching point P1 and the teaching point P2) in which the orientation of the control objective part P changes rapidly, and the operation instruction adjusting unit 48 automatically adjusts the operation instruction in which the orientation of the control objective part P changes rapidly.

FIG. 5A illustrates an example of a section detection window 60. The display part 41 displays the section detection window 60 based on the command of the section detecting unit 47. The section detection window 60 includes a threshold value input box 61 and a section detection execution button 62. According to the examples of FIG. 3A and FIG. 3B in which the orientation of the control objective part P does not change rapidly, it is preferable to input 15 deg/sec into the threshold value input box 61 as the threshold value 43 of the orientation change per unit time. Alternatively, in another embodiment, 0.3 deg/mm may be input to the threshold value input box 61 as the threshold value 43 of the orientation change per unit distance. The input threshold value 43 is stored in the storage part 42 and can be used as the threshold value for the next and subsequent section detection.

The section detecting unit 47 detects a section in the operation program 44 in which the orientation of the control objective part P changes rapidly, based on the command of the section detection execution button 62. According to the examples of FIG. 4A and FIG. 4B in which the orientation of the control objective part P changes rapidly, the orientation change of the control objective part P per unit time becomes 150 deg/sec between the teaching point P1 and the teaching point P2, and the orientation change of the control objective part P per unit distance becomes 3 deg/mm. Thus, the section detecting unit 47 detects the section between the teaching point P1 and the teaching point P2 as a section in which the orientation change (150 deg/sec or 3 deg/mm) of the control objective part P per unit time or unit distance becomes the threshold value 43 (15 deg/sec or 0.3 deg/mm) or greater. The display part 41 displays the operation trajectory window 50 that highlights the section (between the teaching point P1 and the teaching point P2) including the rapid orientation change, based on the command of the section detecting unit 47.

FIG. 6A illustrates an example of the operation trajectory T that does not include a rapid orientation change, and FIG. 6B illustrates an example of an operation trajectory T that includes a rapid orientation change. As illustrated in FIG. 6A, when the operation trajectory T does not include a rapid orientation change, the display part 41 displays the operation trajectory window 50 with the operation trajectory T displayed as a thin broken line or the like, and the display part 41 displays the operation trajectory window 50 with the teaching points P1 to P3 displayed as a black circle or the like. On the other hand, as illustrated in FIG. 6B, when the operation trajectory T includes a rapid orientation change, the display part 41 displays the operation trajectory window 50 that highlights a section S (between the teaching point P1 and the teaching point P2), in which the orientation of the control objective part P changes rapidly, with a thick solid line or the like, based on the command of the section detecting unit 47. The display part 41 may display the operation trajectory window 50 that highlights the teaching point P2 (target position) with a white circle or the like, based on the command of the section detecting unit 47. Alternatively, in another embodiment, the display part 41 may highlight both the teaching point P1 (current position) and the teaching point P2 (target position) constituting the section S with white circles or the like, based on the command of the section detecting unit 47.

In another embodiment, the section detecting unit 47 may sequentially detect the section S, in which the orientation of the control objective part P changes rapidly, during execution of the operation program 44. According to the examples of FIG. 4A and FIG. 4B in which the orientation of the control objective part P changes rapidly, the orientation change of the control objective part P per unit time becomes 150 deg/sec between the teaching point P1 and the teaching point P2, and the orientation change of the control objective part P per unit distance becomes 3 deg/mm. Thus, the section detecting unit 47 sequentially detects the section between the teaching point P1 and the teaching point P2 as the section S in which the orientation change (150 deg/sec or 3 deg/mm) of the control objective part P per unit time or unit distance becomes the threshold value 43 (15 deg/sec or 0.3 deg/mm) or greater. The display part 41 displays an operating speed window 70 that highlights the section S (between the teaching point P1 and the teaching point P2) including the rapid orientation change, based on the command of the section detecting unit 47.

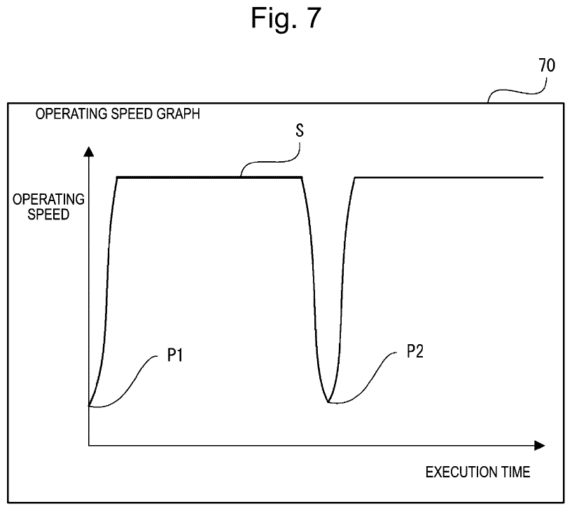

FIG. 7 is a diagram that illustrates an example of the operating speed window 70 including a rapid orientation change. The display part 41 displays the operating speed window 70 that highlights the section S (between the teaching point P1 and the teaching point P2) including the rapid orientation change, based on the command of the section detecting unit 47. The operating speed window 70 includes an operating speed graph for the execution time of the operation program 44. The display part 41 highlights the section S including the rapid orientation change with a thick solid line or the like. In the present example, since the control objective part P is positioned in the teaching point P1 and the teaching point P2, the orientation of the control objective part P is changed in the section S in which the operating speed of the control objective part P becomes constant. Thus, only the section S, in which the operating speed of the control objective part P becomes constant, is highlighted.

The section detecting function can automatically detect the section S in which the orientation of the control objective part P changes rapidly from within the operation program 44 or during execution of the operation program 44. Thus, the time required to modify the operation program 44, which includes a particularly large number of teaching points, can be shortened. This provides the operation program 44 of the machine 2 with high safety and reliability. In addition, the section highlighting function enables the user to visually and easily recognize the section S in which the orientation of the control objective part P changes rapidly.

FIG. 5B is a diagram illustrating an example of the operation instruction adjusting window 63. When the section detecting unit 47 detects the section S in which the orientation of the control objective part P changes rapidly, the display part 41 displays the operation instruction adjusting window 63 that displays an execution confirmation as to whether or not the operation instruction of the section S is to be automatically adjusted based on the command of the section detecting unit 47. The operation instruction adjusting window 63 includes an operation instruction adjustment execution button 64 and a cancel button 65. The operation instruction adjusting unit 48 automatically adjusts the operation instruction of the section S when the operation instruction adjustment execution button 64 is pressed. On the other hand, the operation instruction adjusting unit 48 allows the operation instruction of the section S to be manually adjustable when the cancel button 65 is pressed. The operation instruction adjustment confirmation function allows the user to optionally select automatic adjustment or manual adjustment of the operation instruction.

FIG. 5C is a diagram illustrating an example of an operation instruction adjusting method selection window 66. When the operation instruction adjustment execution button 64 is pressed in the operation instruction adjusting window 63, the display part 41 displays the operation instruction adjusting method selection window 66, based on the command of the operation instruction adjusting unit 48. The operation instruction adjusting method selection window 66 includes an operating speed change button 67 and an operation form change button 68. The operation instruction adjusting unit 48 changes the operating speed of the operation instruction when the operating speed change button 67 is pressed. On the other hand, the operation instruction adjusting unit 48 changes the operation form of the operation instruction when the operation form change button 68 is pressed.

For example, the operation instruction adjusting unit 48, when the operating speed change button 67 is pressed, changes the speed form of the movement speed (e.g., 30 mm/sec) of the control objective part P to the speed form of the orientation change speed of the control objective part P, and decelerates the speed parameter of the orientation change speed of the control objective part P to a predetermined value (e.g., 15 deg/sec) or less. Alternatively, in another embodiment, the operation instruction adjusting unit 48, when the operating speed change button 67 is pressed, changes the speed form of the movement speed (e.g., 30 mm/sec) of the control objective part P to the speed form of the movement time between the teaching points of the control objective part P, and increases the movement time between the teaching points of the control objective part P to a predetermined value (e.g., 10 sec) or greater.

FIG. 8A is a diagram illustrating an example of the program editing window 80 after changing the operating speed. When the operating speed is changed by the operation instruction adjusting unit 48, the display part 41 displays in the program editing window 80 an operation instruction 81 in which the movement speed (e.g., 30 mm/sec) of the control objective part P is changed to the orientation change speed (e.g., 15 deg/sec), based on the command of the operation instruction adjusting unit 48. The display part 41 highlights the operation instruction 81, whose operating speed is changed, with a background color, underline, or the like, based on the command of the operation instruction adjusting unit 48. The display part 41 displays the operation program 44 that simultaneously displays the operation instruction before adjusting (linear movement P2 30 mm/sec) and the operation instruction after adjusting (linear movement P2 15 deg/sec), based on the command of the operation instruction adjusting unit 48.

FIG. 8B is a diagram illustrating a modified example of the program editing window 80 after changing the operating speed. When the operating speed is changed by the operation instruction adjusting unit 48, the display part 41 displays in the program editing window 80 the operation instruction 81 in which the movement speed (e.g., 30 mm/sec) of the control objective part P is changed to the movement time between the teaching points (e.g., 10 seconds), based on the command of the operation instruction adjusting unit 48. The display part 41 highlights the operation instruction 81, whose operating speed is changed, with a background color, underline, or the like, based on the command of the operation instruction adjusting unit 48. The display part 41 displays the operation program 44 that simultaneously displays the operation instruction before adjusting (linear movement P2 30 mm/s) and the operation instruction after adjusting (linear movement P2 10 sec), based on the command of the operation instruction adjusting unit 48.

The operating speed change function changes the speed form, and thus the user can intuitively recognize the orientation change of the control objective part P after the change. The change of the speed parameter can suppress the rapid orientation change of the control objective part P. This provides the operation program 44 of a machine with high safety and reliability. In addition, the operation instruction highlighting function enables the user to visually and easily recognize the automatically adjusted operation instruction. Furthermore, the operation instruction display function before and after adjusting enables the user to visually and easily recognize how the operation instruction has been automatically adjusted.

Referring again to FIG. 5C, the operation instruction adjusting unit 48, when the operation form change button 68 is pressed, changes the operation form of the linear movement of the control objective part P to the operation form of each axis movement, and, as needed, decelerates the speed parameter of the operating speed of the actuator 20 of each joint axis to a predetermined value (e.g., 10% of the maximum operating speed) or less. Alternatively, in another embodiment, the operation instruction adjusting unit 48, when the operation form change button 68 is pressed, changes the operation form of the linear movement of the control objective part P to the operation form of the arc movement, and, as needed, decelerates the speed parameter of the operating speed of the control objective part P to a predetermined value (e.g., 10% of the maximum operating speed) or less.

FIG. 9A and FIG. 9B are diagrams illustrating an example of the operation trajectory windows 50 after changing the operation form. When the operation form is changed by the operation instruction adjusting unit 48, the display part 41 displays, in the operation trajectory window 50, the operation trajectory T in which the operation form of the linear movement of the control objective part P to the teaching point P2 is changed to the operation form of each axis movement, based on the command of the operation instruction adjusting unit 48. Alternatively, in another embodiment, the display part 41 displays, in the operation trajectory window 50, the operation trajectory T in which the operation form of the linear movement of the control objective part P to the teaching point P2 is changed to the operation form of arc movement, based on the command of the operation instruction adjusting unit 48.

FIG. 10 is a diagram illustrating an example of the program editing window 80 after changing the operation form. When the operation form is changed by the operation instruction adjusting unit 48, the display part 41 displays an operation instruction 82, in the program editing window 80, which changes the operation form of the linear movement of the control objective part P to the operation form of each axis movement based on the command of the operation instruction adjusting unit 48, and decelerates the speed parameter of the operating speed of the actuator 20 of each joint axis to a predetermined value (e.g., 10% of the maximum operating speed) or less. The display part 41 highlights the operation instruction 82, whose operation form is changed, with a background color, underline, or the like, based on the command of the operation instruction adjusting unit 48. Further, the display part 41 displays the operation program 44 that simultaneously displays the operation instruction before adjusting (linear movement P2 30 mm/sec) and the operation instruction after adjusting (each axis movement P2 10%), based on the command of the operation instruction adjusting unit 48.

Since the movement distance of the control objective part P is extended by the operation form change function, the rapid orientation change of the control objective part P can be suppressed. This provides the operation program 44 of a machine with high safety and reliability. The operation instruction highlighting function enables the user to visually and easily recognize the automatically adjusted operation instruction. Furthermore, the operation instruction display function before and after adjusting enables the user to visually and easily recognize how the operation instruction has been automatically adjusted.

According to the above embodiments, the section S in which the orientation of the control objective part P changes rapidly can be automatically detected by the section detecting unit 47. Additionally, the operation instruction in which the orientation of the control objective part P changes rapidly can be automatically adjusted by the operation instruction adjusting unit 48. Thus, the time required to modify the operation program 44, which includes a particularly large number of teaching points, can be shortened. This provides the operation program 44 of a machine with high safety and reliability.

When the controller 3 includes the section detecting unit 47, the section S, in which the orientation of the control objective part P changes rapidly, can be automatically detected. When the controller 3 includes the operation instruction adjusting unit 48, the operation instruction in which the orientation of the control objective part P changes rapidly can be automatically adjusted, and the operation of the machine 2 can be controlled according to the adjusted operation instruction. This provides a control technique of the machine 2 with high safety and reliability.

When the mechanical system 1 includes the section detecting unit 47, the section S, in which the orientation of the control objective part P changes rapidly, can be automatically detected. When the mechanical system 1 includes the operation instruction adjusting unit 48, the operation instruction in which the orientation of the control objective part P changes rapidly can be automatically adjusted, and the operation of the machine 2 can be controlled according to the adjusted operation instruction. This provides a control technique of the machine 2 with high safety and reliability.

The above-described program or software may be provided by recording on a computer readable non-transitory recording medium, such as a CD-ROM, or may be delivered and provided from a server device on a wide area network (WAN) or local area network (LAN) via wire or radio.

Although various embodiments are described above, it is to be appreciated that the present invention is not limited to the above-described embodiments and that various modifications may be made within the scope described in the following claims.

### REFERENCE SIGNS LIST

1 Mechanical system (Robot system)
2 Machine (Robot)
3 Controller
4 Program creation device
5 Program creation software
10 First link (Base)
11 Second link (Rotary barrel)
12 Third link (First arm)
13 Fourth link (Second arm)
14 Fifth link (First wrist element)
15 Sixth link (Second wrist element)
16 Seventh link (Third wrist element)
17 Tool
20 Actuator
30 Control unit
40 Input part
41 Display part
42 Storage part
43 Threshold value
44 Operation program
45 Program editing unit
46 Program executing unit
47 Section detecting unit
48 Operation instruction adjusting unit
50 Operation trajectory window
60 Section detection window
61 Threshold value input box
62 Section detection execution button
63 Operation instruction adjusting window
64 Operation instruction adjustment execution button
65 Cancel button
66 Operation instruction adjusting method selection window
67 Operating speed change button
68 Operation form change button
70 Operating speed window
80 Program editing window
81 Operation instruction with operating speed changed
82 Operation instruction with operation form changed
C1 Machine coordinate system
C2 Tool coordinate system
C2′ Tool coordinate system after movement
J1 to J6 Axis line
P Control objective part
P1 to P3 Teaching point
S Section
T Operation trajectory

1. A program creation device comprising an operation instruction adjusting unit configured to adjust an operation instruction in an operation program of a machine, based on an orientation change of a control objective part of the machine per unit distance or unit time in a movement path of the control objective part.

2. The program creation device of claim 1, further comprising a section detecting unit configured to detect a section in which the orientation change of the control objective part per unit distance or unit time is equal to or greater than a threshold value.

3. The program creation device of claim 2, further comprising an input part configured to input the threshold value of the orientation change of the control objective part per unit distance or unit time.

4. The program creation device of claim 2, further comprising a display part configured to display an operation trajectory that highlights at least one selected from a group of the detected section and teaching points constituting the section.

5. The program creation device of claim 2, wherein the section detecting unit is configured to detect the section in which the orientation change of the control objective part per unit distance or unit time is equal to or greater than the threshold value, by evaluating a distance between teaching points in the operation program, an operating speed or an operating time between the teaching points, and the orientation change of the control objective part between the teaching points.

6. The program creation device of claim 2, wherein the section detecting unit is configured to detect the section in which the orientation change of the control objective part per unit distance or unit time is equal to or greater than the threshold value, by evaluating sequentially the orientation change of the control objective part per unit distance or unit time during execution of the operation program.

7. The program creation device of claim 1, wherein the operation instruction adjusting unit is configured to adjust the operation instruction of a section in which the orientation change of the control objective part per unit distance or unit time is equal to or greater than a threshold value.

8. The program creation device of claim 1, wherein the operation instruction adjusting unit includes, as a method of adjusting the operation instruction, at least one selected from a group of an operating speed change function for changing an operating speed of the operation instruction and an operation form change function for changing an operation form of the operation instruction.

9. The program creation device of claim 8, wherein the operation instruction adjusting unit is configured to change, by the operating speed change function, a speed form of the operation instruction and a speed parameter corresponding to the speed form.

10. The program creation device of claim 1, further comprising a display part configured to display the operation program that highlights the adjusted operation instruction.

11. The program creation device of claim 1, further comprising a display part configured to display the operation program that displays the operation instruction before the adjustment and the operation instruction after the adjustment simultaneously.

12. The program creation device of claim 1, further comprising a display part configured to display an execution confirmation of automatic adjustment of the operation instruction.

13. A program creation device comprising a section detecting unit configured to detect a section in which an orientation change of a control objective part of a machine per unit distance or unit time in a movement path of the control objective part is equal to or greater than a threshold value.

14. A controller, comprising:
an operation instruction adjusting unit configured to adjust an operation instruction of a machine, based on an orientation change of a control objective part of the machine per unit distance or unit time in a movement path of the control objective part; and
a control unit configured to control the operation of the machine according to the adjusted operation instruction.

15. A mechanical system, comprising:
a machine;
an operation instruction adjusting unit configured to adjust an operation instruction of the machine, based on an orientation change of a control objective part of the machine per unit distance or unit time in a movement path of the control objective part; and
a control unit configured to control operation of the machine according to the adjusted operation instruction.
